(19) United States
(12) Patent Application Publication
(10) Pub. No.: US 2005/0270766 A1
(43) Pub. Date: Dec. 8, 2005

(54) Liquid crystal display device and backlight module thereof

(75) Inventors: Ta-Kun Kung, Taipei (TW); Yu-Sheng Lin, Hsinchu City (TW); Chang Mo Chiu, Taipei (TW); Yi-Chun Lu, Taipei City (TW); Yen-Chun Chou, Taipei County (TW)

Correspondence Address: BIRCH STEWART KOLASCH & BIRCH, PO BOX 747, FALLS CHURCH, VA, 22040-0747, US

(73) Assignee: Prodisc Technology Inc.

(21) Appl. No.: 10/968,946

(22) Filed: Oct. 21, 2004

(30) Foreign Application Priority Data
Jun. 8, 2004 (TW) 093116459

(51) Int. Cl. G09F 13/04

(52) U.S. Cl. 362/97; 362/224; 362/246; 362/332; 362/311

(57) ABSTRACT

A backlight module comprises a light transmissive substrate, an optical film, and at least one light source. In this case, the optical film has a first surface and a second surface opposite to the first surface. The first surface of the optical film is connected to the transparent surface, and the second surface of the optical film has at least one fresnel area. The light source is disposed at one side of the light transmissive substrate.

### BACKGROUND OF THE INVENTION

1. Field of Invention

The invention relates to a display device and a backlight module thereof and, in particular, to a liquid crystal display device and a backlight module thereof.

2. Related Art

In general, since flat display devices are thin, low weight and low power consumption, they are increasingly being used in various applications. Among the various types of flat panel display devices, liquid crystal display devices are widely used for cellular phones, personal digital assistants, portable personal computers, monitors, and liquid crystal televisions, etc. because of their superiority in resolution, color image display, weight, contrast and display quality.

LCD devices use the optical anisotropy by an electric field that is applied across the liquid crystal molecules to produce a predetermined image. A specific orientation can be modified by the electric field that is applied across the liquid crystal molecules. By controlling the applied voltage, the LCD device provides various transmittances for rays of light to display image data.

As shown in FIG. 1, a conventional large-sized liquid crystal display 1 includes a liquid crystal module 11, a prism sheet 12, a diffuser 13, a light source 14, a reflector 15, and a casing 16. The light source 14 emits light. One part of the light emits to the diffuser 13, and the reflector 15 reflects other part of the light from the light source 14 in a direction to the diffuser 13. The light passes sequentially through the diffuser 13, the prism sheet 12, and the liquid crystal module 11, and then emits to the viewer. Herein, the liquid crystal module 11 controls the passing time and the passing order of the light to display image data. The prism sheet 12 has a plurality of triangular prisms with the same size and the same shape. When the light passes through the prism sheet 12, the light from the diffuser 13 can converge toward the liquid crystal module 11, so that the regularly directional light is emitted toward the liquid crystal module 11. Herein, the prism sheet 12 is used for increasing the brightness of the liquid crystal display 1. And, the light source 14 may be a L shape lamp or a n shape lamp in the large-sized liquid crystal display 1.

However, there are two disadvantages in the conventional large-sized liquid crystal display 1. First, because the prisms of the prism sheet 12 all have the same shape and the same size, the degree of light convergence of the light may be constant. If the demand of wide view angle is satisfied, the emitted light may be scatted, so that the brightness of the central portion is not high enough. On the other hand, if the demand of brightness of the central portion is satisfied, the view angle of the liquid crystal display 1 may not be wide enough. So, the conventional large-sized liquid crystal display 1 couldn't have both advantages of high brightness in the central portion and wide view angle at the same time. Second, because of the shape (L shape or n shape) and the size of the light source 14, dark bands may appear easily at the side portions of the liquid crystal display 1. So, luminance uniformity of the liquid crystal display 1 may be decreased.

### SUMMARY OF THE INVENTION

In view of the above, the invention is to provide a liquid crystal display device and a backlight module thereof could adjust the emitting angle and the emitting direction of the light emitted from the backlight module.

Therefore, to achieve the above, a backlight module according to the invention comprises a light transmissive substrate, an optical film, and at least one light source. In this case, the optical film has a first surface and a second surface opposite to the first surface. The first surface of the optical film is connected to the transparent surface, and the second surface of the optical film has at least one fresnel area. The light source is disposed at one side of the light transmissive substrate.

To achieve the above, a liquid crystal display device according to the invention comprises a liquid crystal module, a light transmissive substrate, an optical film, and at least one light source. In this case, the optical film has a first surface and a second surface opposite to the first surface. The first surface of the optical film is connected to the transparent surface, and the second surface of the optical film has at least one fresnel area. The light source is disposed at one side of the light transmissive substrate and the light transmissive substrate is disposed between the liquid crystal module and the light source.

As mentioned above, the liquid crystal display device and the backlight module according to the invention could control the emitting angle and the emitting direction of the light emitted from the backlight module. Compare to the prior art, the liquid crystal display device and the backlight module according to the invention have the fresnel area with at least one focal point. So, the invention could control the emitting angle and the emitting direction of the emitted light to satisfy the need of brightness and view angle in many different cases. Take a liquid crystal TV for an example, the invention could both satisfy the need of wide view angle and high brightness. Moreover, the invention could solve the problem that the dark bands appear at the side portions of the liquid crystal display device in the conventional large-sized liquid crystal display. Furthermore, the invention may increase the uniform of the liquid crystal display device.

### BRIEF DESCRIPTION OF THE DRAWINGS

The invention will become more fully understood from the detailed description given hereinbelow illustration only, and thus is not limitative of the present invention, and wherein:

FIG. 1 is a partially enlarged schematic view showing a large size liquid crystal display in the prior art;

FIG. 2 and FIG. 3 are partially enlarged schematic views showing backlight modules according to the first embodiment of the invention;

FIG. 4 is another partially enlarged schematic view showing a backlight module according to the first embodiment of the invention;

FIG. 5 and FIG. 6 are other partially enlarged schematic views showing backlight modules according to the first embodiment of the invention; and

FIG. 7 is a partially enlarged schematic view showing a liquid crystal display device according to the second embodiment of the invention.

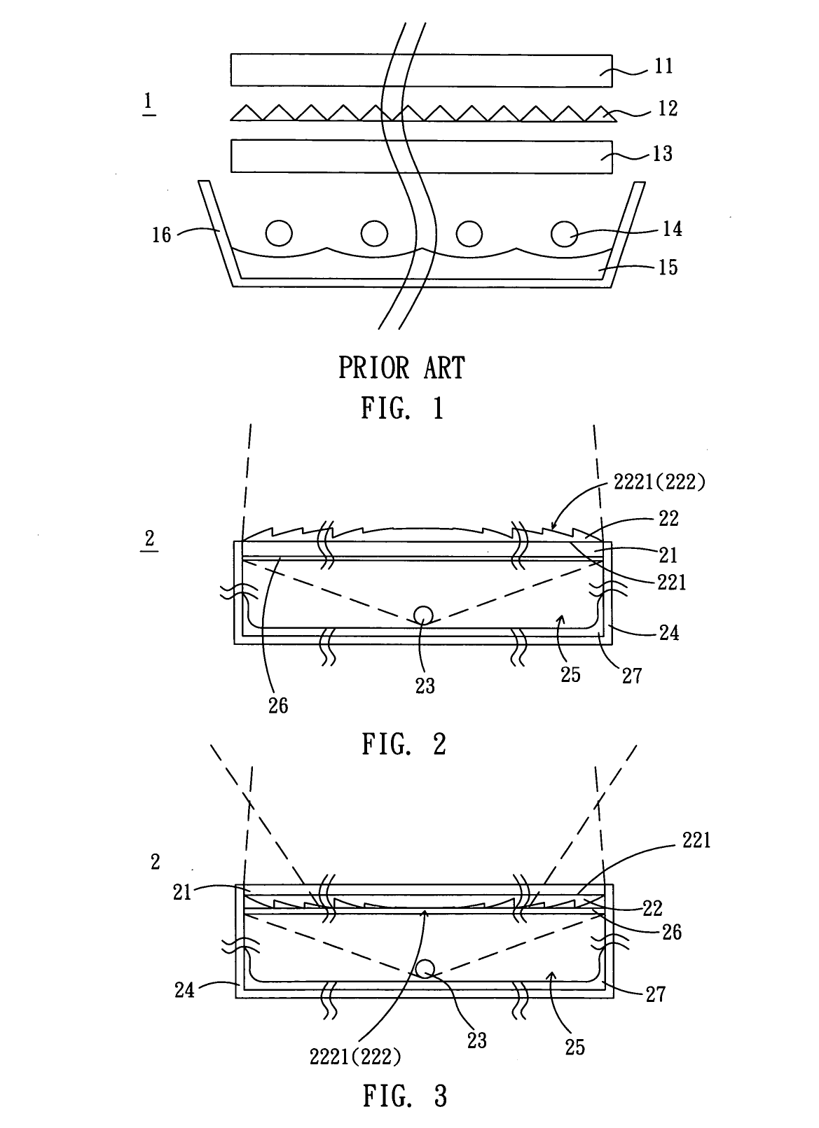

### DETAILED DESCRIPTION OF THE INVENTION

The liquid crystal display device and the backlight module thereof will be described below with reference to relevant drawings.

For describing easily and clearly, the embodiments will be described below with the partially enlarged schematic views.

Please refer to FIG. 2, the backlight module 2 according the first embodiment comprises a light transmissive substrate 21, an optical film 22, and at least one light source 23. In this case, the optical film 22 has a first surface 221 and a second surface 222 opposite to the first surface 221. The first surface 221 of the optical film 22 is connected to the transparent surface 21, and the second surface 222 of the optical film 22 has at least one fresnel area 2221. The light source 23 is disposed at one side of the light transmissive substrate 21.

The backlight module 2 according the present embodiment further comprises a casing 24, as shown in FIG. 2. The casing 24 has an opening, and the light transmissive substrate 21 is connected to the opening of the casing 24. A storage space 25 is formed between the casing 24 and the light transmissive substrate 21, and the light source 23 is attached to the casing 24 and disposed in the storage space 25.

In the present embodiment, the light transmissive substrate 21 is a substrate which may be passed through by light. For example, the light transmissive substrate 21 may be a flexible substrate or a rigid substrate. The light transmissive substrate 21 may also be a plastic substrate or a glass substrate. Herein, the plastic substrate or the flexible substrate may be a polycarbonate (PC) substrate, a polyester (PET) substrate, a cyclic olefin copolymer (COC) substrate or a metallocene-based cyclic olefin copolymer (mCOC) substrate.

In the present embodiment, the optical film 22 has at least one fresnel area 2221, and the fresnel area 2221 has at least one focal point. Please refer to FIG. 2 again, the optical film 22 has one fresnel area 2221, and the fresnel area 2221 has one focal point.

In the present embodiment, when the light passes through the fresnel area 2221, the emitting angle of the light is relative to the relative position between the light source 23 and the focal point of the fresnel area 2221. In the present embodiment, the optical path may be same as, but not limited to, the optical path as shown in FIG. 2.

Furthermore, as shown in FIG. 3, the fresnel area 2221 has two focal points. Herein, because the fresnel area 2221 has two focal points, one part of the light emitted from the light source 23 may converge toward the central portion of the backlight module 2 to increase the brightness of the central portion. And, the other part of the light emitted from the light source 23 may emit to the side portions of the backlight module 2 to compensate the brightness of the side portions.

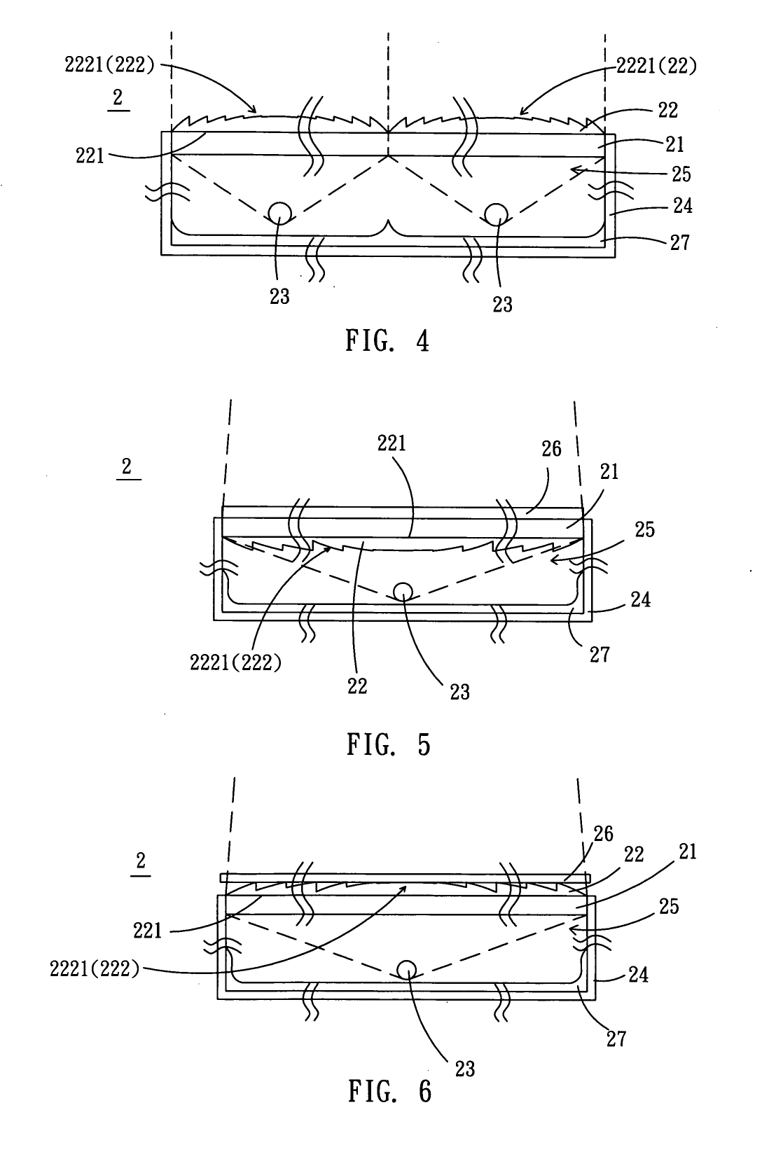

Moreover, the optical film 22 may also have a plurality of fresnel areas 2221. As shown in FIG. 4, the optical film 22 has two fresnel areas 2221.

In the present embodiment, the fresnel area 2221 may be a linear fresnel lens. Furthermore, the shape and the size of the fresnel area 2221 may be adjusted by the real need.

In addition, as shown in FIG. 2, the light transmissive substrate 21 may be disposed between the light source 23 and the optical film 22. Moreover, the optical film 22 may be disposed between the light transmissive substrate 21 and the light source 23, as shown in FIG. 3.

In the present embodiment, the shape of the light source 23 may be a linear light source or a U shape light source, and the like. In addition, the light source 23 of the present embodiment may be a fluorescent tube (for example, a cold cathode fluorescent lamp, CCFL), a light-emitting diode array (LED array) or an organic light emitting diode (OLED), and the like.

In the present embodiment, a quantity of the light source 23 is substantially equal to a quantity of the fresnel area 2221, and the position of the light source 23 is related to the position of the fresnel area 2221. For example, when the backlight module 2 has a plurality of light sources 23, each light source 23 is disposed near the central portion of each fresnel area 2221, as shown in FIG. 4. In addition, when the light source 23 is a linear light source and the fresnel area 2221 is a linear fresnel lens, the light source 23 is parallel to the fresnel area 2221.

Moreover, the backlight module 2 of the present embodiment may be mixed with diffusion powder. In the present embodiment, the light transmissive substrate 21 may be mixed with diffusion powder. And, the optical film 22 may also be mixed with diffusion powder. In the present embodiment, the diffusion powder may correct the emitting angle of the emitted light and may also enhance the scattering effect so that the backlight module 2 may form the uniform surface light.

Please refer to FIG. 2 and FIG. 5, the backlight module 2 of the present embodiment further comprises a diffuser 26. The light transmissive substrate 21 may be disposed between the optical film 22 and the diffuser 26. Herein, the diffuser 26 may be disposed on the light transmissive substrate 21, as shown in FIG. 2 and FIG. 5. Also, the diffuser 26 may be disposed near the light transmissive substrate 21 (not shown).

In addition, the optical film 22 may also be disposed between the light transmissive substrate 21 and the diffuser 26. Herein, the diffuser 26 may be disposed on the optical film 22, as shown in FIG. 3 and FIG. 6. Furthermore, the diffuser 26 may be disposed near the optical film 22 (not shown).

Moreover, at least a surface of the light transmissive substrate 21 has at least one pattern (for example, dot pattern, prismatic pattern or notch). The pattern may enhance the scattering effect and may also decrease the reflecting effect of the light. The pattern may also increase the diffusion effect. In the present embodiment, the pattern is on the surface of the light transmissive substrate 21. As shown in FIG. 5, the pattern may be on a first surface 221 of the light transmissive substrate 21. Also, as shown in FIG. 6, the pattern may be on a second surface 212 of the light transmissive substrate 21. Furthermore, the pattern may be both on the first surface 211 and the second surface 212.

In addition, the backlight module 2 of the present embodiment further comprises a reflector 27. Herein, the reflector 27 may be disposed on the casing 24 and may be disposed between the light source 23 and the casing 24. In the present embodiment, the reflector 27 may reflect the scattering light to the light transmissive substrate 21 so that the reflector 27 may increase the utilization of the light and may also increase the brightness of the backlight module 2. Herein, the reflector 27 may be made of, but not limited to, Aluminum (Al).

In the present embodiment, the backlight module 2 may be, but not limited to, a backlight module of a liquid crystal display.

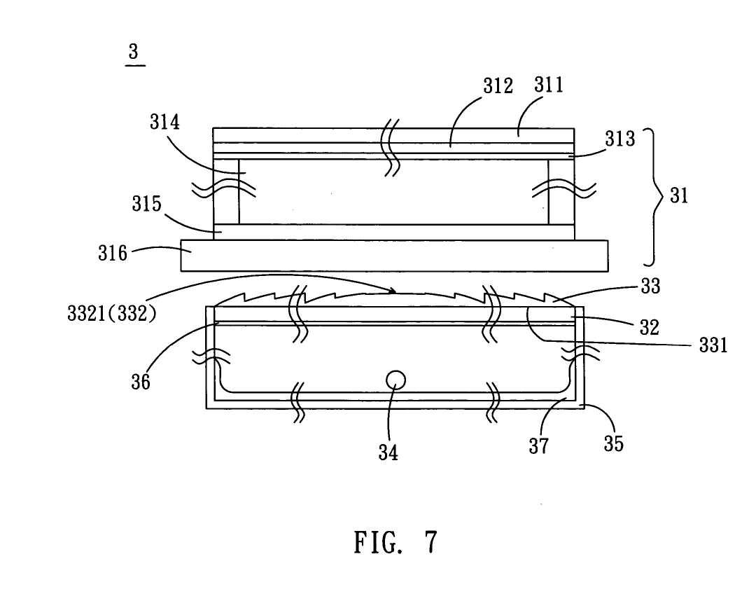

As shown in FIG. 7, the liquid crystal display 3 according to the second embodiment of the invention comprises a liquid crystal module 31, a light transmissive substrate 32, an optical film 33, and at least one light source 34. In this case, the optical film 33 has a first surface 331 and a second surface 332 opposite to the first surface 331. The first surface 331 of the optical film 33 is connected to the transparent surface 32, and the second surface 322 of the optical film 32 has at least one fresnel area 3321, and the light source 34 is disposed at one side of the light transmissive substrate 32 and the light transmissive substrate 32 is disposed between the liquid crystal module 31 and the light source 34.

In the present embodiment, the liquid crystal display 3 further comprises a casing 35, a diffuser 36 and a reflector 37.

In the present embodiment, the characteristics and functions of the light transmissive substrate 32, the optical film 33, the light source 34, the casing 35, the diffuser 36 and the reflector 37 are the same as the same elements in the first embodiment, and detailed descriptions thereof will be omitted.

In addition, the liquid crystal module 31 of the present embodiment includes a first polarizing plate 311, a filter 312, a first electrode 313, a liquid crystal layer 314, a thin film transistor (TFT) 315 and a polarizing plate 316. Herein, the elements of the liquid crystal module 31 may be adjusted by the real need.

As shown in FIG. 7, the emitted light from the light source 34 passes sequentially through the diffuser 36, the light transmissive substrate 32, the optical film 33 and liquid crystal module 37. Then, the thin film transistor 315 controls the orientation of each liquid crystal cell of the liquid crystal layer 314. Each liquid crystal cell controls the brightness and the passing time of the emitted light to display an image which viewers see.

Furthermore, the fresnel area 3321 has two focal points. Herein, because the fresnel area 3321 has two focal points (as shown in FIG. 3), one part of the light emitted from the light source 34 may concentrate to the central area to increase the brightness of the central area. And, the other part of the light emitted from the light source 34 may emit to the side portions of the liquid crystal display device 3 to compensate the brightness of the side portions. Herein, the liquid crystal display 3 may both have the advantages of the wide view angle and the high brightness.

As mentioned above, the liquid crystal display device and the backlight module according to the invention could control the emitting angle and the emitting direction of the light emitted from the backlight module. Compare to the prior art, the liquid crystal display device and the backlight module according to the invention have the fresnel area with at least one focal point. So, the invention could control the emitting angle and the emitting direction of the emitted light to satisfy the need of brightness and view angle in many different cases. Take a liquid crystal TV for an example, the invention could both satisfy the need of wide view angle and high brightness. Moreover, the invention could solve the problem that the dark bands appear at the side portions of the liquid crystal display device in the conventional large-sized liquid crystal display. Furthermore, the invention may increase the uniform of the liquid crystal display device.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A backlight module, comprising:
a light transmissive substrate;
an optical film having a first surface and a second surface opposite to the first surface, the first surface of the optical film connected to the light transmissive substrate, the second surface of the optical film having at least one fresnel area; and
at least one light source disposed at one side of the light transmissive substrate.

2. The backlight module according to claim 1, further comprising a casing having an opening, the light transmissive substrate connected to the opening of the casing, a storage space formed between the casing and the light transmissive substrate, the light source attached to the casing and disposed in the storage space.

3. The backlight module according to claim 1, wherein the optical film is disposed between the light transmissive substrate and the light source.

4. The backlight module according to claim 1, wherein the light transmissive substrate is disposed between the light source and the optical film.

5. The backlight module according to claim 1, wherein the fresnel area has at least one focal point.

6. The backlight module according to claim 1, wherein the fresnel area is a linear fresnel lens.

7. The backlight module according to claim 1, wherein the light source is a linear light source, a cold cathode fluorescent tube (CCFL) or a light-emitting diode array (LED array).

8. The backlight module according to claim 1, wherein a quantity of the light source is substantially equal to a quantity of the fresnel area, the position of the light source is related to the position of the fresnel area.

9. The backlight module according to claim 1, further comprising a diffuser wherein the light transmissive substrate is disposed between the optical film and the diffuser.

10. The backlight module according to claim 9, wherein the diffuser is disposed near the light transmissive substrate or disposed on the light transmissive substrate.

11. The backlight module according to claim 1, further comprising a diffuser wherein the optical film is disposed between the light transmissive substrate and the diffuser.

12. The backlight module according to claim 11, wherein the diffuser is disposed near the optical film or disposed on the optical film.

13. The backlight module according to claim 1, wherein the light transmissive substrate and/or the optical film is mixed with diffusion powder.

14. The backlight module according to claim 1, wherein at least one pattern is formed on at least one surface of the light transmissive substrate.

15. A liquid crystal display, comprising:
a liquid crystal module;
a light transmissive substrate;
an optical film having a first surface and a second surface opposite to the first surface, the first surface of the optical film connected to the transparent surface, the second surface of the optical film having at least a fresnel area; and
at least one light source disposed at one side of the light transmissive substrate, and the light transmissive substrate disposed between the liquid crystal module and the light source.

16. The liquid crystal display according to claim 15, further comprising a casing having an opening, the light transmissive substrate connected to the opening of the casing, a storage space formed between the casing and the light transmissive substrate, the light source attached to the casing and disposed in the storage space.

17. The liquid crystal display according to claim 15, wherein the optical film is disposed between the light transmissive substrate and the light source.

18. The liquid crystal display according to claim 15, wherein the light transmissive substrate is disposed between the light source and the optical film.

19. The liquid crystal display according to claim 15, wherein the fresnel area has at least one focal point.

20. The liquid crystal display according to claim 15, wherein the fresnel area is a linear fresnel lens.

21. The liquid crystal display according to claim 15, wherein the light source is a linear light source, a cold cathode fluorescent tube (CCFL) or a light-emitting diode array (LED array).

22. The liquid crystal display according to claim 15, wherein a quantity of the light source is substantially equal to a quantity of the fresnel area, the position of the light source is related to the position of the fresnel area.

23. The liquid crystal display according to claim 15, further comprising a diffuser wherein the light transmissive substrate is disposed between the optical film and the diffuser.

24. The liquid crystal display according to claim 23, wherein the diffuser is disposed near the light transmissive substrate or disposed on the light transmissive substrate.

25. The liquid crystal display according to claim 15, further comprising a diffuser wherein the optical film is disposed between the light transmissive substrate and the diffuser.

26. The liquid crystal display according to claim 25, wherein the diffuser is disposed near the optical film or disposed on the optical film.

27. The liquid crystal display according to claim 15, wherein the light transmissive substrate and/or the optical film is mixed with diffusion powder.

28. The liquid crystal display according to claim 15, wherein at least one pattern is formed on at least one surface of the light transmissive substrate.
